(19) United States
(12) Patent Application Publication
(10) Pub. No.: US 2003/0192210 A1
(43) Pub. Date: Oct. 16, 2003

(54) License plate holder

(76) Inventor: Michael Leibman, Queens, NY (US)

Correspondence Address: HOWARD C. MISKIN, C/O STOLL, MISKIN, & BADIE, THE EMPIRE STATE BUILDING, 350 FIFTH AVENUE SUITE 4710, NEW YORK, NY, 10118, US

(21) Appl. No.: 10/120,231

(22) Filed: Apr. 10, 2002

(51) Int. Cl. G09F 7/00

(52) U.S. Cl. 40/209

(57) ABSTRACT

A license plate holder made of a tough, resilient material has a back support with walls extending from the back support along the perimeter, defining a thick border and a well for mounting a license plate. The height of the walls is higher than the thickness of the license plate to provide adequate protection of the license plate mounted therein

### FIELD OF THE INVENTION

The invention relates to a license plate holder made of a resilient material that provides protection to the vehicle and the license plate mounted thereon.

### BACKGROUND OF THE INVENTION

Every motor vehicle is generally required to have at least a license plate mounted at the front or rear of the vehicle. Typically, a license plate holder is placed in the front of the vehicle affixed to the front bumper. Similarly, if a license plate is to be placed at the rear of the vehicle, it is affixed to the rear bumper. The license plate and license plate holder becomes the first point of contact when the vehicle bumped into or by another vehicle or an object.

Prior art license plate holder normally comprises a thin, flat, plastic or metal frame having a border of about ½ inch and a flat back support substantially the same size as the license plate. The back support is typically mounted with screws on the front or rear bumper of the vehicle. A license plate is placed on top of the back support and the frame is then mounted over the license plate with nuts and bolts passing through the frame, license plate and back support. When a vehicle bumped into or is bumped by another vehicle or an object, for example, while parking the vehicle, the license plate and the prior art license plate holder are easily damaged. The thinness of the plastic frame of the prior art license plate holder often cracks when bumped into another vehicle or an object. Also, if the force is large enough, the bumper or body of the vehicle may be damaged.

Therefore, there is a need for an improved license plate holder that protects both the vehicle and the license plate mounted thereon.

### SUMMARY OF THE INVENTION

The present invention provides a license plate holder including a back support having at least two walls extending away from the back support along the perimeter, defining a border and a well for mounting a license plate. The height of the walls from the back support are preferably higher than the thickness of the license plate so as to provide adequate protection of the license plate mounted within the walls. The license plate holder of the present invention is preferably made of a tough resilient material such as resilient plastic or rubber by a molding process to create a single unitary unit.

Advantageously, the border is generally thick to provide strength and that combined with the height of the wall and the resiliency of the material, provides protection to both the vehicle and the license plate mounted on the license plate holder in a simple manner.

### BRIEF DESCRIPTION OF THE DRAWINGS

A preferred embodiment of the present invention has been chosen for purposes of illustration and description and is shown in the accompanying drawings forming a part of the specification wherein:

FIG. 1 is a front view of the license plate holder of the present invention.

FIG. 2 is a cross sectional view taken at line 2-2 of FIG. 1.

FIG. 3 shows another embodiment of the license plate holder of the present invention with the back face of the back support contoured.

FIG. 4 shows another embodiment of the license plate holder of the present invention with two opposed walls.

FIG. 5 is a cross sectional view similar to FIG. 2 showing another embodiment of the license plate holder of the present invention with cavities in the walls.

FIG. 6 is a cross sectional view similar to FIG. 2 showing another embodiment of the license plate holder of the present invention with hollow walls.

FIG. 7 is a cross sectional view similar to FIG. 2 showing another embodiment of the license plate holder of the present invention with grooves on the wall.

FIG. 8 is another embodiment of the license plate holder of the present invention providing an area for indicia.

### DETAILED DESCRIPTION OF THE PREFERRED EMBODIMENTS

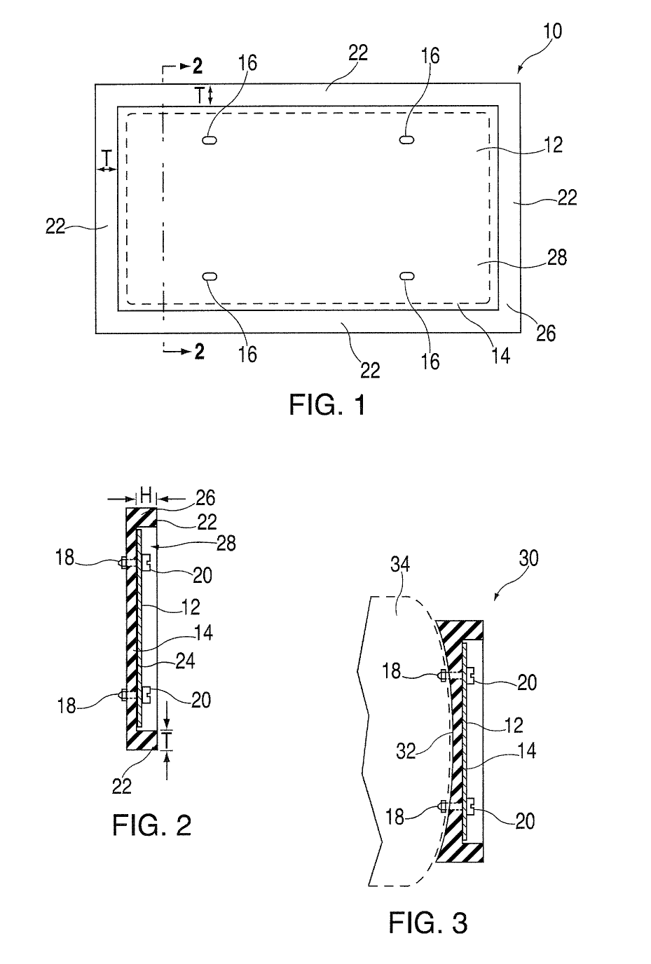

With reference to the drawings, wherein the same reference number indicates the same element throughout, there is shown in FIGS. 1 and 2 the license plate holder 10 of the present invention with a license plate 12 (shown in dotted line) mounted thereon. The license plate holder 10 comprises a rectangular back support 14 having a plurality of holes 16 for mounting the license plate 12 on the holder 10 with nuts 18 and bolts 20.

In one embodiment, a wall 22 extends substantially perpendicularly from the front face 24 of a generally rectangular shaped back support 14 along the entire perimeter of the back support 14, creating a border 26 having a thickness, T, advantageously shown to be approximately ¾ inch and defining a well 28. The well 28 is slightly larger than the outer perimeter of the license plate 12 for mounting the license plate 12 into the well 28 and against the front face 25 of the back support 14. The height, H, of the wall 22 extending from the back support 14 is preferably larger than the thickness of the license plate 12 to provide adequate protection of the license plate 12 mounted therein. The height, H, of the wall 22 may be approximately ¾ inch.

The license plate holder 10 is preferably made of a tough resilient material such as resilient plastic or rubber, preferably by a molding process to create a single integral unit. The license plate holder 10 can also be made from dense foam or polypropylene. Preferably, the license plate holder 10 is reflective and made of a fluorescent material.

FIG. 3 shows an alternative embodiment of the license plate holder 30, identical to the license plate holder 10 shown in FIGS. 1 and 2, except that the back face 32 of the back support 14 is contoured to the shape of the bumper 34 of the vehicle. This can be readily accomplished during the molding process.

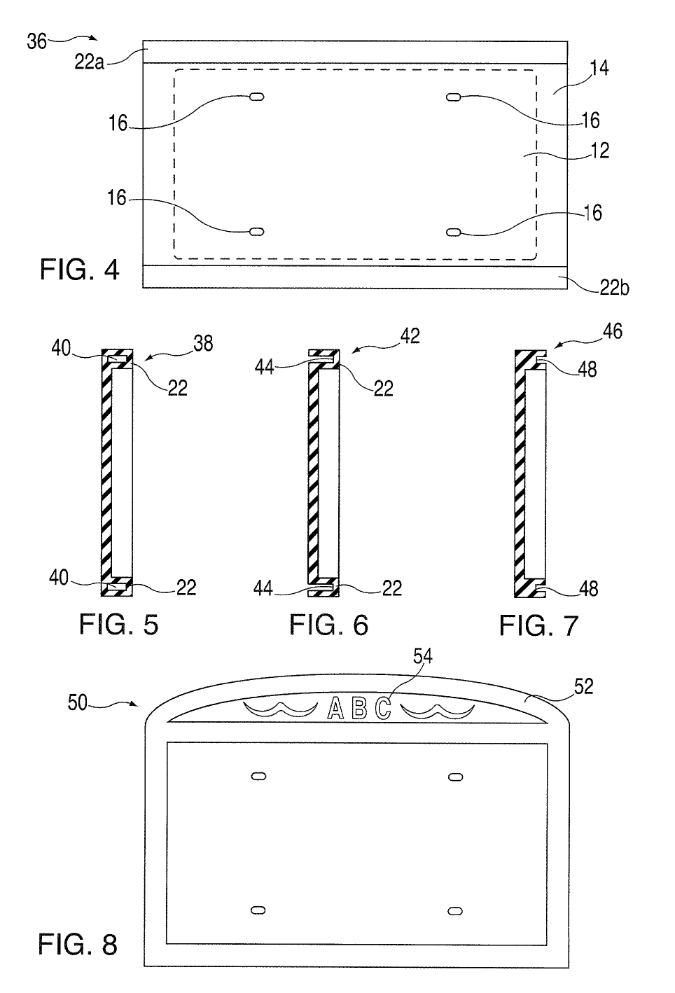

FIG. 4 shows another embodiment of the license plate holder 36, identical to the license plate holder 10 shown in FIGS. 1 and 2, except that the wall 22 includes two opposite walls 22a and 22b along the perimeter of the back support 14. Although FIG. 4 shows two horizontal walls 22a and 22b, two opposite vertical walls along the perimeter of the back support 14 may also be used.

FIG. 5 shows another embodiment of the license plate holder 38, identical to the license plate holder 10 shown in FIGS. 1 and 2. Each wall 22 contains a cavity 40 to reduce the raw material required for and the weight of the license plate holder 38. The cavities 40 advantageously provide additional cushioning to protect the vehicle when it bumps into another vehicle or an object.

FIG. 6 shows another embodiment of the license plate holder 42, identical to the license plate holder 10 shown in FIGS. 1 and 2. Each wall 22 is hollow 44 to reduce the raw material required for and the weight of the license plate holder 42.

FIG. 7 shows another embodiment of the license plate holder 46, identical to the license plate holder 10 shown in FIGS. 1 and 2. Grooves 48 along the top surface of each wall 48 are provided for placement of indicia (not shown), such as a dealership's name and telephone number, advertisement or other text and graphics, within said grooves 48.

FIG. 8 is another embodiment of the license plate holder 50, similar to the license plate holder 10 shown in FIGS. 1 and 2. Extending from the top of the license plate holder 50 is an area 52 for placement of indicia 54, such as a dealership's name and telephone number, advertisement, or other text and graphics. The extended area 52 advantageously provides additionally protection to the vehicle and the license plate held therein. Although the extended area 52 is shown in FIG. 8 to extend from the top of the license plate holder 50, the extended area 52 may extend from the left, right or bottom of the license plate holder 50 and may take on another different shape and forms.

Although certain features of the invention have been illustrated and described herein, other better modifications and changes will occur to those skilled in the art. It is, therefore, to be understood that the appended claims are intended to cover all such modification and changes that fall within the spirit of the invention.

What I claim is:

1. A license plate holder for mounting a license plate having a thickness on a vehicle, comprising:
(a) a back support having a front face; and
(b) at least one wall extending substantially perpendicular from said front face along the perimeter of said back support, said wall defining a border and a well adapted to enclose and hold said license plate, said wall having a height and a thickness.

2. The license plate holder of claim 1, wherein said height of said wall is larger than the thickness of said license plate.

3. The license plate holder of claim 1, wherein said height of said wall extends beyond the license plate when said license plate is in said well.

4. The license plate holder of claim 1, wherein said back support and said wall are made of resilient material.

5. The license plate holder of claim 1, wherein said back support and said wall are made of resilient plastic.

6. The license plate holder of claim 1, wherein said back support and said wall are made of rubber.

7. The license plate holder of claim 1, wherein said back support and said wall are made of dense foam.

8. The license plate holder of claim 1, wherein said back support and said wall are made of polypropylene.

9. The license plate holder of claim 1, wherein said back support and said wall are made of a fluorescent material.

10. The license plate holder of claim 1, wherein said back support and said wall are made of a reflective material.

11. The license plate holder of claim 1, wherein said back support and said wall are one unitary unit.

12. The license plate holder of claim 11, wherein said back support and said wall are molded.

13. The license plate holder of claim 1, wherein said height of said wall is approximately ¾ inch.

14. The license plate holder of claim 1, wherein said thickness of said wall is approximately ¾ inch.

15. The license plate holder of claim 1, wherein said front face is substantially flat.

16. The license plate holder of claim 1, wherein said back support further having a rear face.

17. The license plate holder of claim 16, wherein said rear face is substantially flat.

18. The license plate holder of claim 16, wherein said rear face is contoured to the shape of the vehicle.

19. The license plate holder of claim 16, wherein said rear face is concaved.

20. The license plate holder of claim 1, wherein said back support having a plurality of holes adapted to mount said license plate thereon with nuts and bolts.

21. The license plate holder of claim 1, wherein said wall comprises first and second opposite walls along the perimeter of said back support.

22. The license plate holder of claim 1, wherein said wall comprises a first, second, third and fourth walls along the entire perimeter of said back support.

23. The license plate holder of claim 1, wherein said wall having a cavity therein.

24. The license plate holder of claim 16, wherein said wall being hollow, with the hollow opening at the rear face of said back support.

25. The license plate holder of claim 1, wherein said wall having a top surface and a groove on said top surface.

26. The license plate holder of claim 1, further comprising an area extending planarly from said back support.

27. A license plate holder for mounting a license plate having a thickness on a vehicle, comprising:
(a) a back support having a front face; and
(b) a wall extending substantially perpendicular from said front face along the perimeter of said back support, defining a border and a well adapted to hold said license plate, said wall having a height and a thickness;
(c) wherein said back support and said wall are one unitary unit made of a resilient material and said height of said wall is larger than the thickness of said license plate.
